(19) United States
(12) Patent Application Publication
(10) Pub. No.: US 2023/0375054 A1
(43) Pub. Date: Nov. 23, 2023

(54) DRUM BRAKE SYSTEM WITH A SHELL

(71) Applicant: HL MANDO CORPORATION, Gyeonggi-do (KR)

(72) Inventors: Hatem SHAHIN, Pfaffenhofen (DE); Kai BRAUN, Friedrichsdorf (DE); Lothar WAGNER, Simmern (DE)

(21) Appl. No.: 18/198,458

(22) Filed: May 17, 2023

(30) Foreign Application Priority Data
May 17, 2022 (DE) 102022204898.9

(51) Int. Cl. F16D 65/00

(52) U.S. Cl. CPC F16D 65/0031; F16D 65/0006; F16D 2250/0084

(57) ABSTRACT

The invention relates to a drum brake system for a vehicle, comprising a brake drum and a shell, the shell at least partially encasing the brake drum at an axially outer side and/or an axially inner side and/or a circumferentially outer side.

### CROSS-REFERENCE TO RELATED APPLICATION

This application is based on and claims priority under 35 U.S.C. § 119 to German Patent Application No. 102022204898.9, filed on May 17, 2022 in the German Patent and Trade Mark Office, the disclosures of which are incorporated herein by reference.

### TECHNICAL FIELD

The present invention is in the field of mechanical engineering. It relates to vehicle technology, in particular vehicle brakes. It is proposed to provide a drum brake system with a shell.

### BACKGROUND

Drum brake systems are known brake systems which feature a brake drum and brake shoes that are pressed against the brake drum for braking.

Even though they have been used and improved over the course of a long time, they continue to have some known disadvantages that have not been satisfactorily solved.

They typically emit noises, such as squeal noises, wherein the brake drum can act as a resonator or amplifier that emits brake noise into to vehicle and into the environment.

They can emit brake dust which may be critical to people's health.

They can show unstable dynamic behaviour and braking performance due to weather or humidity.

They may be subject to corrosion of the drum, which can cause a decline in performance.

### SUMMARY

It is an object of the present invention to solve at least some of the above-mentioned problems and thus provide an improved brake system.

This is achieved by a drum brake system according to claim 1. Advantageous embodiments can be found in the dependent claims and in the following description and the figures.

Correspondingly, a drum brake system for a vehicle comprises a brake drum and a shell. The shell at least partially encases the brake drum at an axially outer side and/or an axially inner side and/or a circumferentially outer side.

By having this encasing, noise emitted from the brake drum is dampened, and the brake parts are protected.

The shell may typically be arranged in a manner distanced from the brake drum. The shell may for instance have a thickness of between 0.5 mm and 2 mm. It may for instance comprise metal and/or plastic.

In an embodiment, the shell may be configured to rotate along with the brake drum. Therein, the shell may for example be attached to a wheel and/or an axle. In particular, the shell may for example be attached to a wheel hub and/or a wheel rim and/or a wheel bearing.

The shell may comprise a first outer segment that is configured to cover at least a portion of the axially outer side of the brake drum. The first outer segment may optionally be connected to the wheel hub and/or the rim. In some cases, it is connected to the wheel hub and/or the rim in a removable manner.

Additionally or alternatively, the shell may comprise a first inner segment, configured to cover at least a portion of the axially inner side of the brake drum. The first inner segment may optionally be connected to the first outer segment, for instance in a removable manner. Additionally or alternatively, the first inner segment may be connected to the rim and/or to an axle, for instance in a removable manner.

The shell may comprise further outer segments and/or further inner segments. They may be connected to the respective first segments.

If the first outer segment and the first inner segment are provided, they may be removably connected to each other.

In an embodiment, the shell is configured to be non-rotating, such that the brake drum rotates within the shell. Therein, the shell may for instance be configured to be attached to a wheel arch.

The shell may for instance comprise at least a first inner segment configured to cover at least a portion of the axially inner side of the brake drum. The first inner segment may be connected to the wheel arch. For instance it may be connected to the wheel arch in a removable manner.

The shell may comprise a coating layer for adhesion of brake dust.

The shell may comprise magnetic inserts for collecting metallic brake dust.

The shell may comprise at least two segments that are connected to each other. The at least two segments may for instance be a first inner segment and a second inner segment, and/or a first inner segment and a first outer segment, and/or a first outer segment and a second outer segment.

The at least to segments may for instance be connected to each other by an adhesive and/or by at least one bolt and/or by at least one screw.

In an example, at least two of the at least two segments are made of a different material from each other.

According to possible examples, the shell comprises for instance an inner portion, which covers at least a portion of the axially inner side of the brake drum, and/or an outer portion, which covers at least a portion of the axially outer side of the brake drum. The aforementioned inner segments may be seen as forming the inner portion of the shell, which covers at least a portion of the axially inner side of the brake drum. Additionally or alternatively, the aforementioned outer segments may be seen as forming the outer portion of the shell, which covers at least a portion of the axially outer side of the brake drum.

In an example, the shell comprises at least to layers, at least in a section of the shell. In an example, the at least two layers are made of different materials from each other.

The shell may for instance be transparent, at least in a section.

The shell may comprise a cleaning arrangement. In an example, the shell comprises at least one cleaning opening, for rinsing an interior space of the shell and/or for applying suction to the inner space of the shell.

In an example, a distance between an inner surface of the shell and the brake drum is at least 10 mm.

In an example, the shell only partially encases the axially outer side and/or the axially inner side of the brake drum, leaving at least 25% of an area of the axially inner side and/or an area of the axially outer side of the brake drum exposed.

The drum brake system having the shell may for instance be configured as a brake system for an electric vehicle and/or as a brake system for a rear axle.

### BRIEF DESCRIPTION OF DRAWINGS

In the following, the invention will be explained in an exemplary fashion with reference to the appended figures. Therein,

FIGS. 1-4 show components of a drum brake system,

FIG. 5 illustrates emission of brake noise from a drum brake,

FIG. 6 shows a drum brake system with a shell,

FIGS. 7, 8 show drum brake systems with shells made of two different materials,

FIGS. 9, 10 show cleaning systems for the shell of the drum brake system,

FIGS. 11-16 show different embodiments of the shell, configured as a rotating shell,

FIGS. 17-22 illustrate attachment of rotating shells,

FIGS. 23, 24 show embodiments of the shell, configured as a non-rotating shell,

FIGS. 25, 26 illustrate a position of the shell with respect to a wheel, and

FIGS. 27-42 show ways of carrying out an inner portion and an outer portion of the shell.

### DETAILED DESCRIPTION

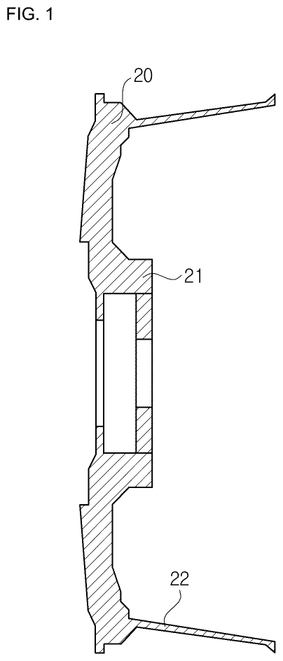

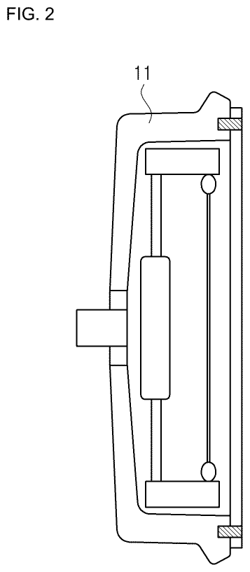

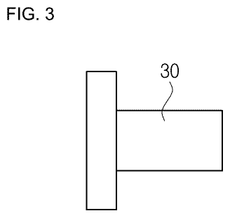

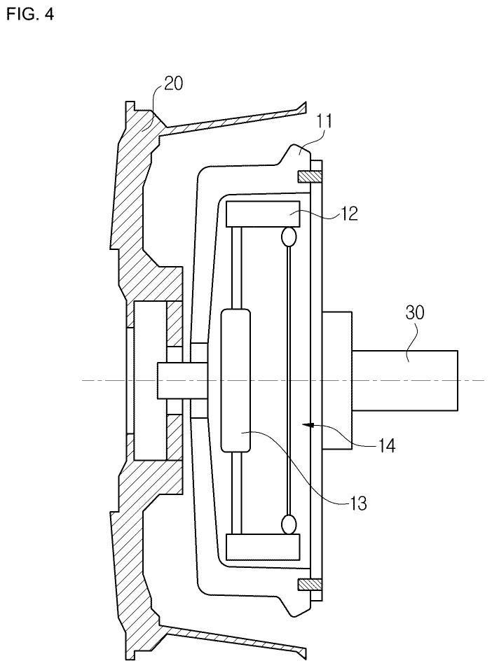

FIGS. 1-4 show components of a drum brake system for a vehicle. FIG. 1 shows a wheel 20, with a central wheel hub 21, and rim 22 for bearing a tire on its outer side. FIG. 2 shows a brake drum 11 that is connectible to the wheel 20, and FIG. 3 shows an axle 30 to which the wheel 20 and the brake drum 11 are to be attached. FIG. 4 shows the components of FIGS. 1-3 in an assembled state. The brake drum 11 rotates along with the wheel 20. A back plate assembly includes brake shoes 12, an actuator mechanism 13 and a retraction mechanism 14. When the brakes are applied, the brake shoes 12 are pressed against the brake drum 11 by way of the actuator mechanism 13, to create friction and decelerate the rotating movement. When the brakes are released, the retraction mechanism aids retraction of the brake shoes from the brake drum.

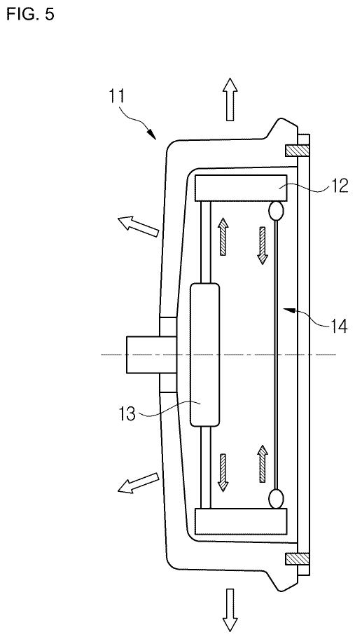

FIG. 5 shows the brake drum 11, including the aforementioned back plate assembly components (cf. FIG. 4). Arrows indicate emission of brake noise. I.e., the components of the brake drum system, including the brake drum, vibrate and resonate and give rise to undesired noise.

Moreover, brake dust is generated as the brake shoes wear down. In the following, a concept is described which helps to protect an environment of the vehicle from noise and brake dust. The drum brake system, at which this concept may be applied, may for instance be a brake system for an electric vehicle and/or a brake system for a rear axle of a vehicle.

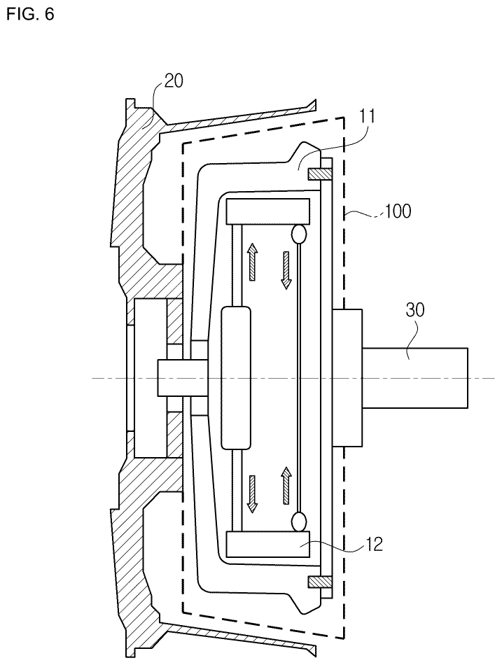

FIG. 6 shows a drum brake system which has been modified according to the present application, to protect the environment from noise and brake dust. The drum brake system comprises the brake drum and a shell 100. Said shell 100 encases the brake drum at an axially outer side, at an axially inner side, and at a circumferentially outer side, providing a hull to all sides, shielding noise, and collecting any dust emitted from the brake shoes 12. A distance between an inner surface of the shell 100 and the brake drum 11 is at least 10 mm.

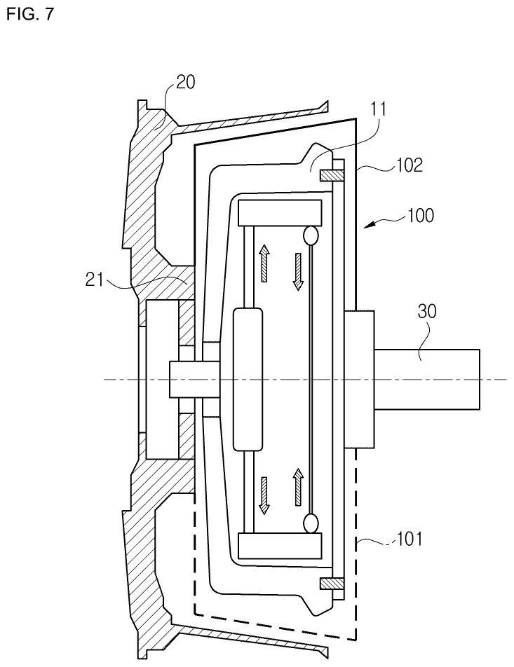

FIG. 7 shows an embodiment of the brake system with the shell 100, wherein the shell 100 comprises two parts, made of a different material from each other, or from the same material. The shell 100 comprises a first half-shell 101, covering half of the brake drum 11, at the axially outer side, at the axially inner side, and at the circumferentially outer side. The shell 100 furthermore comprises a second half-shell 102, covering the remaining half of the brake drum 11, at the axially inner side, and at the circumferentially outer side. The two half-shells 101, 102, together, provide a hull to all sides. The two half shells 101, 102 may be removably connected to each other, allowing assembly and disassembly of the shell 100. Moreover, both half-shells 101, 102 may optionally be connected to the wheel hub 21 and/or the axle 30. In the position shown in the Figure, the first half-shell 101 covers the upper half, and the second half shell 102 covers the lower half. When the wheel 20 and brake drum 11 rotate, the half shells 101, 102 also rotate and thus change their positions.

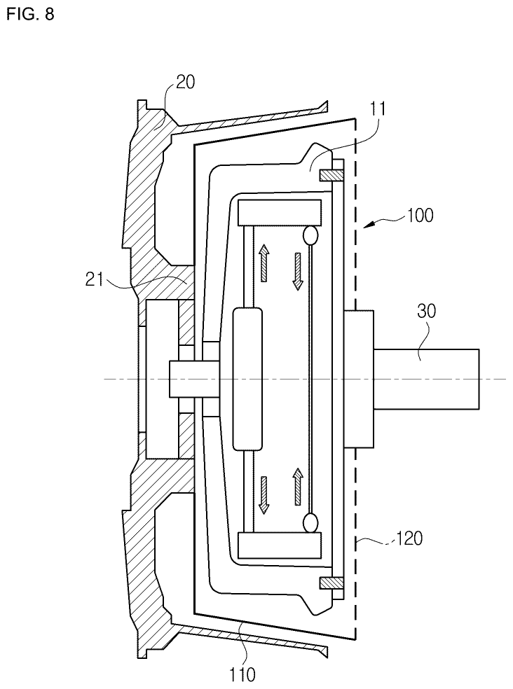

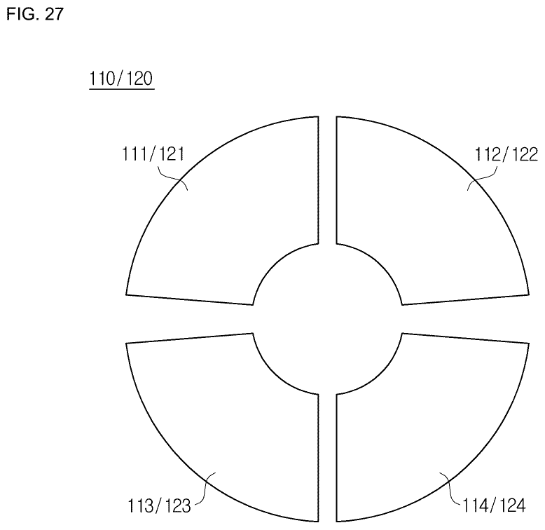

FIG. 8 shows the drum brake system with the shell 100, wherein the shell 100 comprises an outer portion 110 that covers the axially outer side of the brake drum, and also extends over the outer circumferential side of the brake drum 11. The outer portion 110 is connected to the wheel hub 21. The shell 100 furthermore comprises an inner portion 120, covering the brake drum 11 at the axially inner side, and providing a complete hull for the brake drum 11, together with the outer portion 110. The inner portion 120 is removably connected to the outer portion 110 and to the axle 30, allowing assembly and disassembly of the shell 100, enabling for instance access to the brake drum 11 or cleaning of the shell 100. The inner portion 120 and the outer portion 110 may be made of the same material or of different materials from each other. The inner portion 120 and the outer portion 110 may each comprise one or more segments 111, 112, 113, 114, 121, 122, 123, 124, as will be explained for example in the context of FIGS. 27-42.

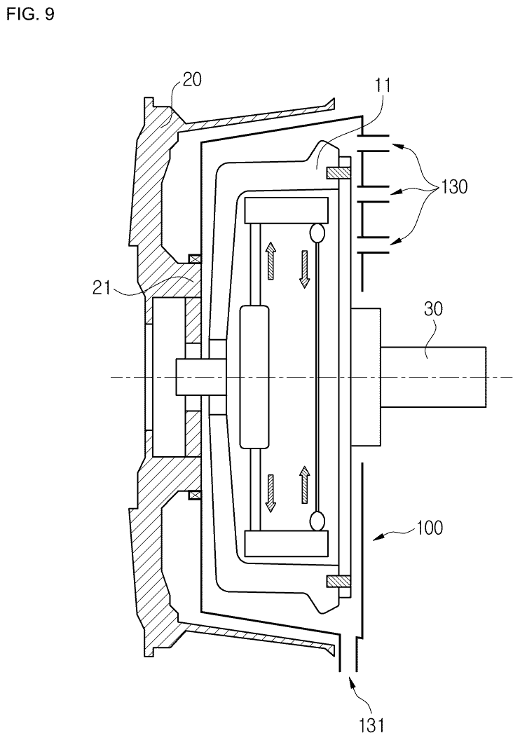

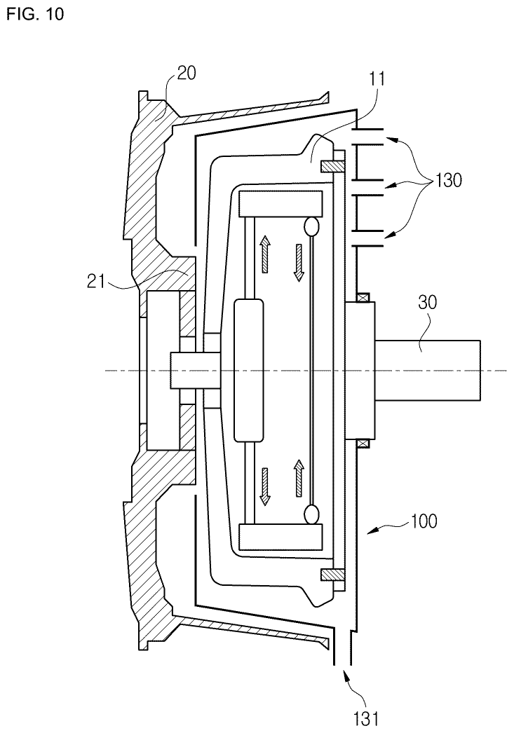

FIGS. 9, 10 show the drum brake system with the shell 100, wherein the shell 100 comprises rinsing and cleaning facilities. Therein, several cleaning openings are provided in the shell 100. The cleaning openings include a plurality of rinsing openings 130 which allow rinsing an interior space of the shell 100, and at least one suction opening 131 is provided, at which suction may be applied, so that dust or dirt may be sucked out. By way of this, brake dust may be removed from the interior of the shell 100. In the embodiment of FIG. 9, the shell 100 is attached to the wheel hub 21, and not to the axle 30. In the embodiment of FIG. 10, the shell is attached to the axle 30, but not to the wheel 20. It is also possible to connect the shell 100 to both the wheel 20 and the axle 30.

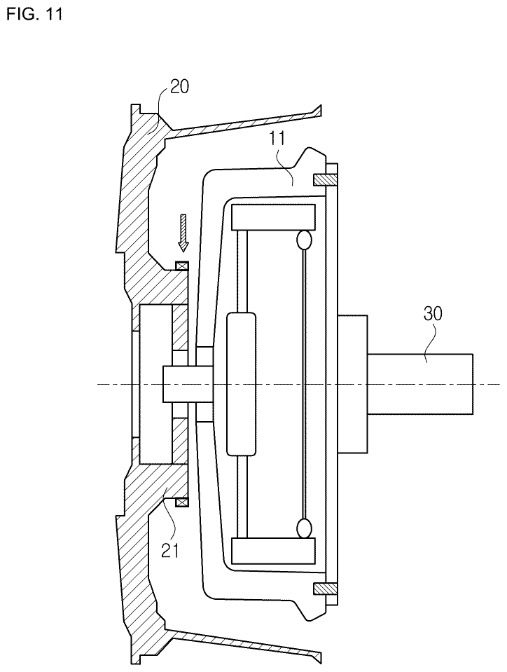

FIGS. 11-16 illustrate different embodiments of the shell 100, wherein the shell 100 covers different portions of the brake drum 11, providing a partial or a full hull for the brake drum 11. In these embodiments, the shell 100 rotates along with the brake drum 11.

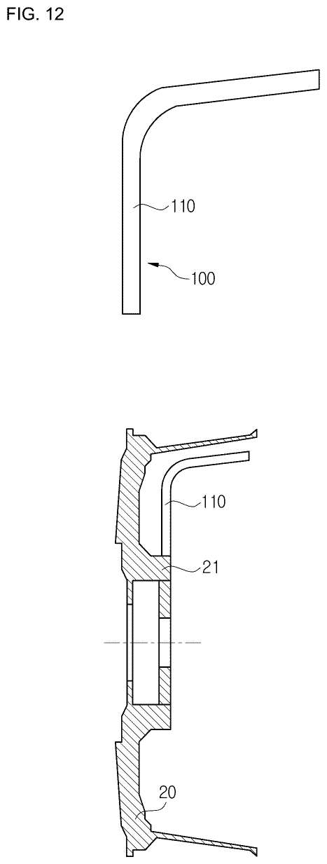

FIG. 11 illustrates the basic setup including the wheel 20, the axle 30, and the brake drum 11. Therein, an arrow highlights the position where the shell 100 may be attached to the wheel hub 21 of the wheel 20, according to the embodiments shown in FIGS. 12-15.

FIGS. 12-16 show, at the top, in a schematic fashion, inner and outer portions 110, 120 of the shells 100 according to the various embodiments. At the bottom, the figures illustrate how these portions 110, 120 of the shells 100 may be connected to the wheel 20. The portions 110, 120 may in each case be composed of one or more segments (cf. FIGS. 27-42).

FIG. 12 shows that the shell 100 comprises an outer portion 110, covering half of an axially outer side of the brake drum 11, and a part of an outer circumferential side of the brake drum 11, and thus providing a quarter hull for the brake drum 11, leaving about 75% of the brake drum 11 exposed.

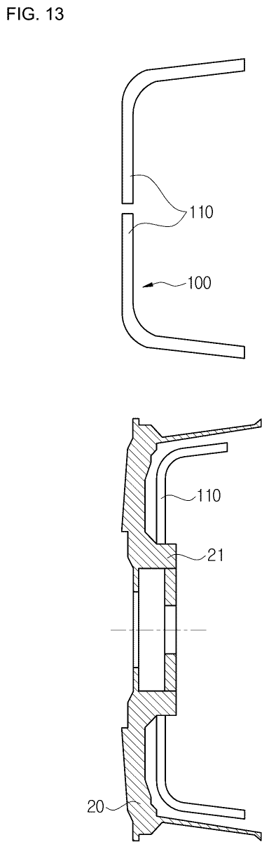

FIG. 13 shows that the shell 100 comprises an outer portion 110, covering all of an axially outer side of the brake drum 11 and a part of an outer circumferential side of the brake drum 11, and thus providing a half hull for the brake drum 11, leaving about 50% of the brake drum 11 exposed.

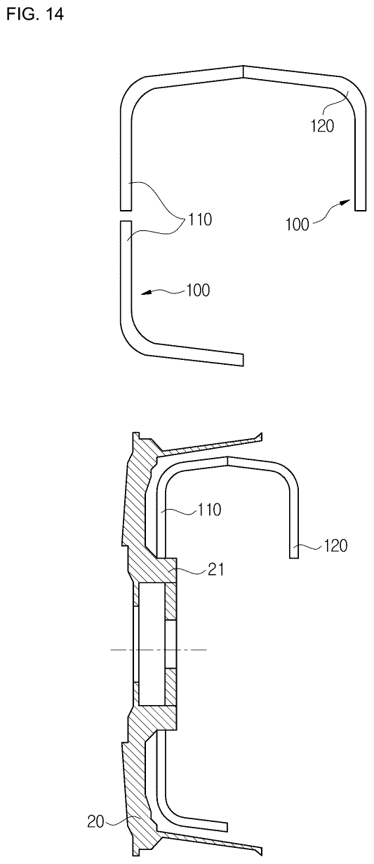

FIG. 14 shows that the shell 100 comprises, in addition to an outer portion 110 like the one shown in FIG. 13, an inner portion 120. The inner portion 120 covers half of an axially inner side of the brake drum 11. The inner portion 120 is connected to the outer portion 110, which in turn is connected to the wheel 20. The outer portion 110 and the inner portion 120, together, form a three-quarter hull for the brake drum 11, leaving 25% of the brake drum 11 exposed.

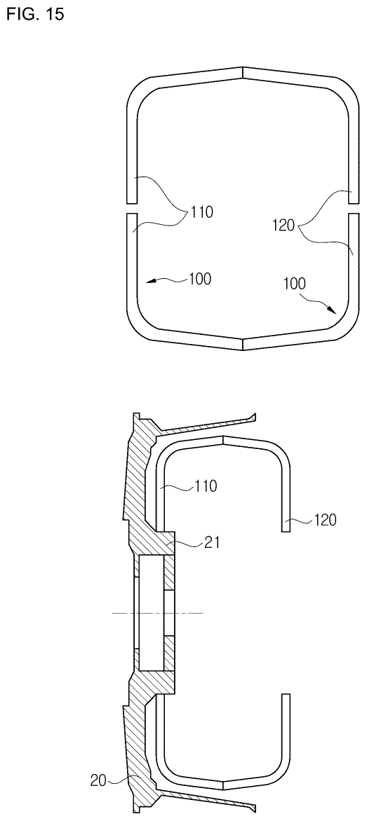

FIG. 15 shows that the shell comprises an outer portion 110 covering all of the axially outer side of the brake drum 11, and a part of an outer circumferential side, and an inner portion 120 covering an axially inner side of the brake drum 11, and the remaining part of the outer circumferential side. The outer portion 110 and the inner portion 120, together, form a full hull for the brake drum, wherein an axle may be passed through a central opening within the inner portion 120. The outer portion 110 is connected to the wheel hub 21, and the inner portion 120 is connected to the outer portion 110. Optionally, the inner portion 120 may be connected or connectible to the axle 30.

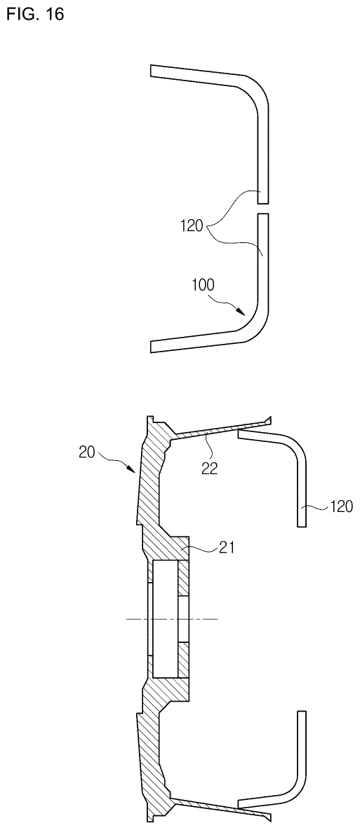

FIG. 16 shows that the shell comprises an inner portion 120, which is configured to cover an axially inner side of the brake drum 11. The inner portion 120 is connected to an inner surface of the rim 22 and rotates along with the wheel 20. The axially outer side of the brake drum 11 may be left without any cover. The inner portion 120 thus provides a half hull for the brake drum 11, leaving half of the brake drum 11, i.e., the outer side, exposed. Optionally, the inner portion 120 may be connected or connectible to the axle 30.

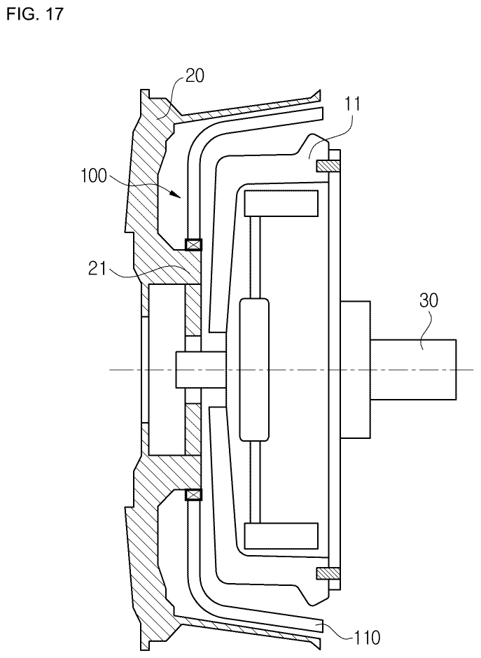

FIGS. 17-22 show embodiments of the brake system, where the shell 100 rotates along with the brake drum 11.

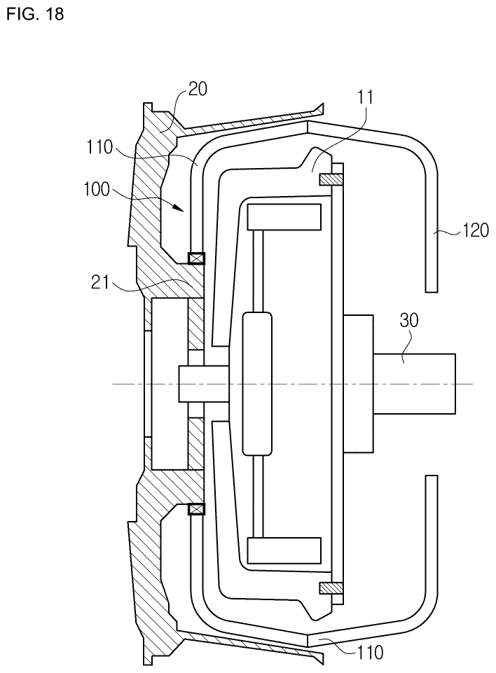

FIGS. 17 and 18 show the shell 100 being attached to a wheel hub 21 of the wheel. In the case of FIG. 17, the shell 100 forms a half hull, as in the case of FIG. 13. In FIG. 17, the brake drum 11 is also displayed. FIG. 18 shows the shell forming a full hull, as in the case of FIG. 16. In FIG. 18, he brake drum 11 is also displayed. The inner portion 120 has a central hole through which the axis 30 passes. There remains a free space around the axis 30.

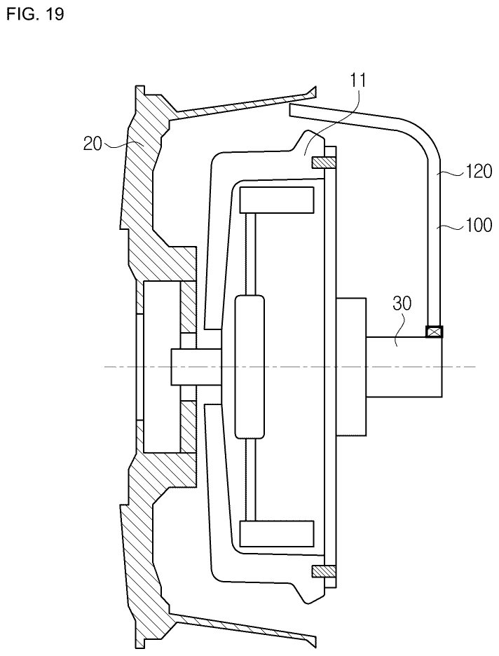

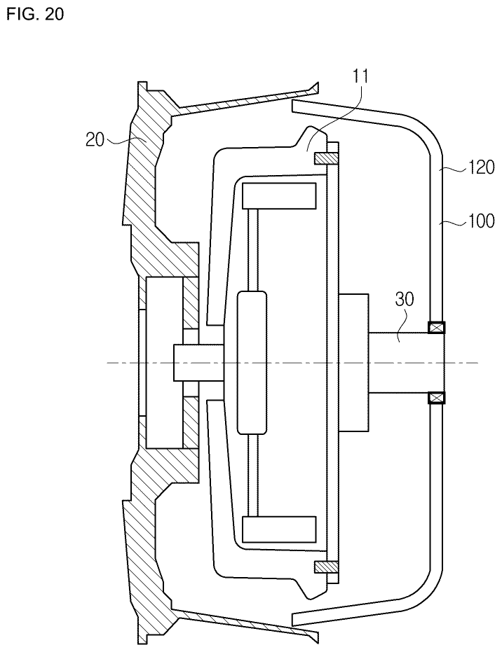

FIGS. 19 and 20 relate to embodiments, where the shell 100 comprises, in each case, only an inner portion 120 that is attached to the axle 30, and no outer portion. In the case of FIG. 19, a quarter hull is provided by way of the inner portion 120 of the shell 100. In the case of FIG. 20 a half hull is provided by way of the inner portion 120 of the shell 100.

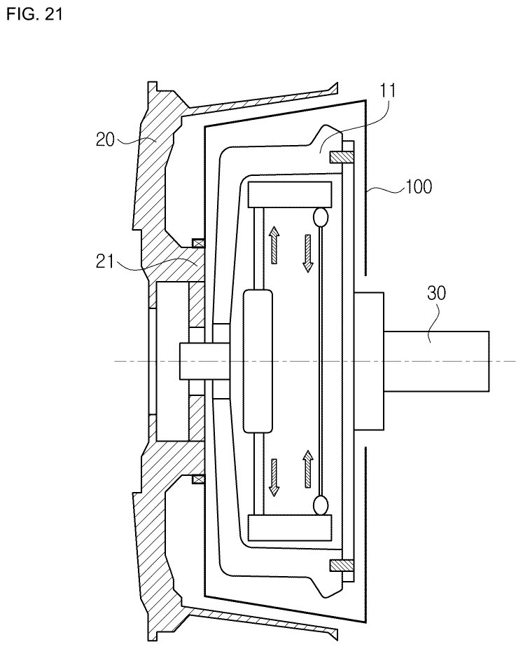

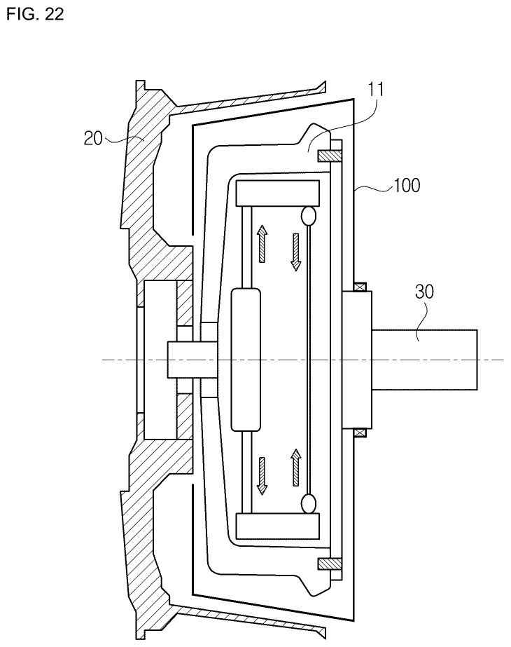

FIGS. 21 and 22 schematically illustrate connection options for attaching the rotating shell 100. According to FIG. 21, the shell 100 may be attached, in particular removably attached, to the wheel hub 21, and there is no connection between the shell 100 and the axle 30. According to FIG. 22, the shell may be attached, in particular removable attached, to the axle 30, and there is no connection between the shell 100 and the wheel 20. In each case, the shell 100 may be composed of several portions or segments that can be disconnected from each other, for disassembling the shell 100.

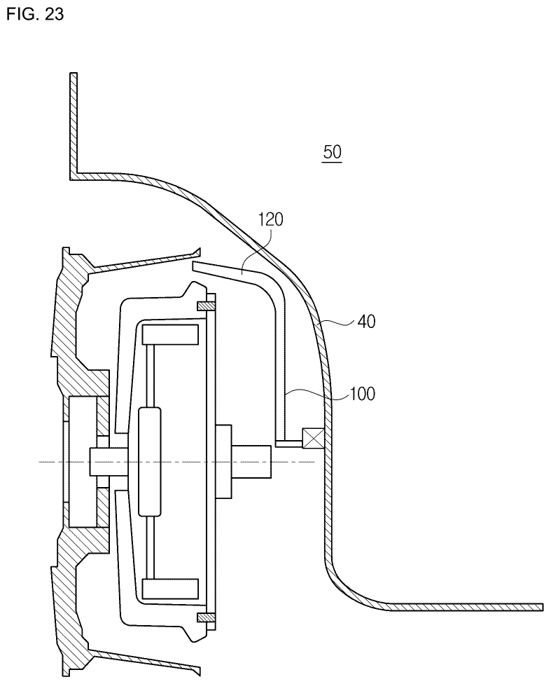

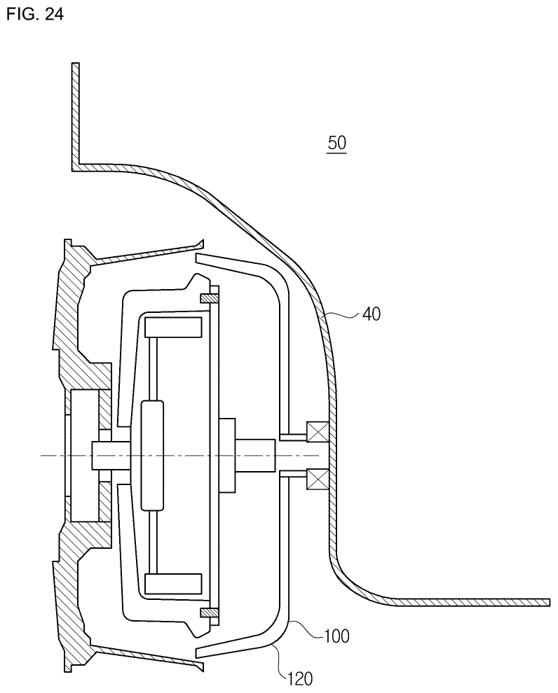

FIGS. 23 and 24 relate to an example where the shell 100 is configured to be non-rotating, such that the brake drum 11 rotates within the shell 100. Therein, the shell 100 is removably attached to a wheel arch 40.

In the case of FIG. 23, the shell comprises an inner portion 120, which is in itself composed of one or more inner segments, the inner portion 120 being configured to cover approximately half of the axially inner side of the brake drum 11.

In the case of FIG. 24, the shell comprises an inner portion 120, which is in itself composed of one or more inner segments, the inner portion 120 being configured to cover all of the axially inner side of the brake drum 11.

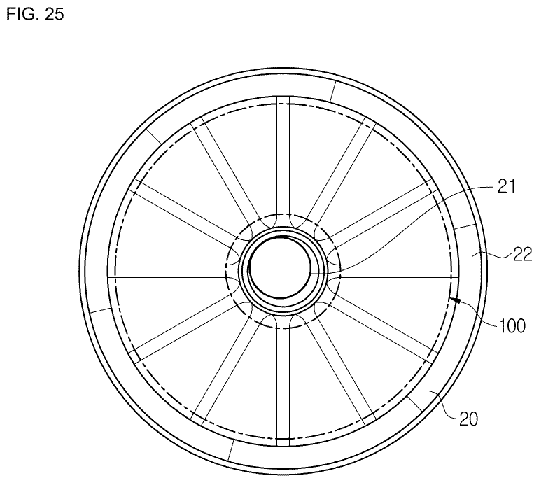

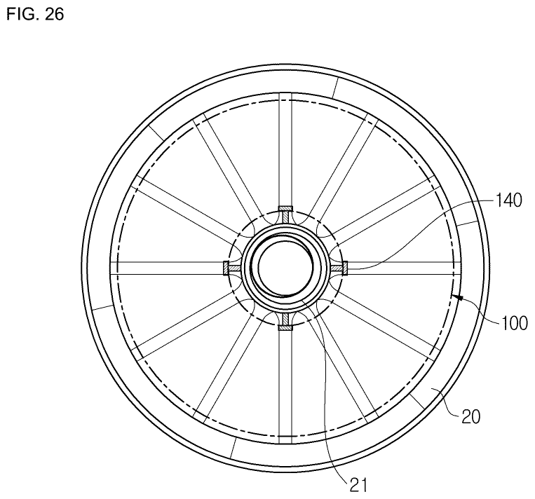

FIGS. 25 and 26 present a view onto a wheel 20, where the positon of the shell 100 according to the present disclosure is indicated. In FIG. 25, boundaries of the shell 100 are schematically shown by dashed-dotted circles. The shell 100 extends in an area between the wheel hub 21 and the rim 22. As shown in FIG. 26, the shell 100 may for instance be connected to the wheel hub 21 by bolts 140.

FIGS. 27-42 show examples for carrying out the shell 100. Therein, views onto the shell 100 are shown. The statements made apply to both the outer portion 110 and the inner portion 120 which may form the shell 100, according to the various embodiments. The portions 110, 120 are composed of segments 111, 112, 113, 114 or 121, 122, 123, 124, each segment covering about a quarter of the respective side of the brake drum 11 on which it is arranged.

According to FIG. 27, the outer portion 110 of the shell 100—as shown for instance in FIGS. 13-15, 17, 18— may comprise a first outer segment 111, a second outer segment 112, a third outer segment 113, and a fourth outer segment 114. In the same way, the inner portion 120 of the shell 100—as shown for instance in FIGS. 15, 16, 18, 20, 24—may comprise a first inner segment 121, a second inner segment 122, a third inner segment 123, and a fourth inner segment 124. The segments may comprise more than one layer, for example two layers. The layers of a segment may be made of different materials from each other. This may aid damping. In an embodiment, the shell 100 is transparent, at least in a section. For instance, one or more of the segments may be transparent.

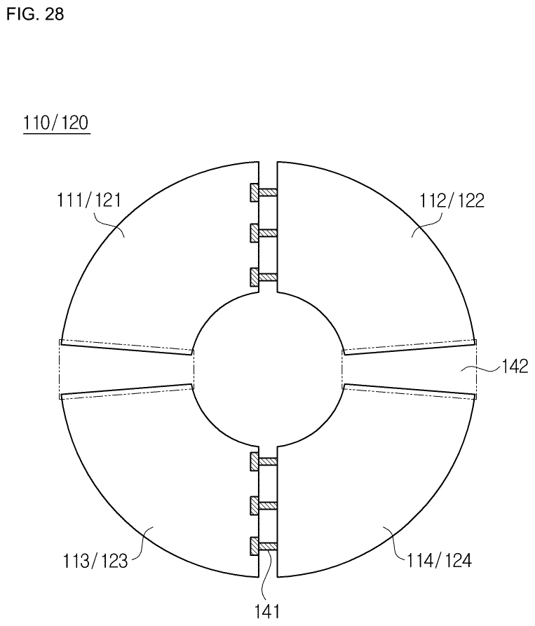

FIG. 28 shows connection options for connecting the segments 111, 112, 113, 114 or 121, 122, 123, 124 to form the outer portion 110 or the inner portion 120. Neighbouring segments are connected by bolts 141 or by way of additional insert elements 142 that are plugged onto the segments.

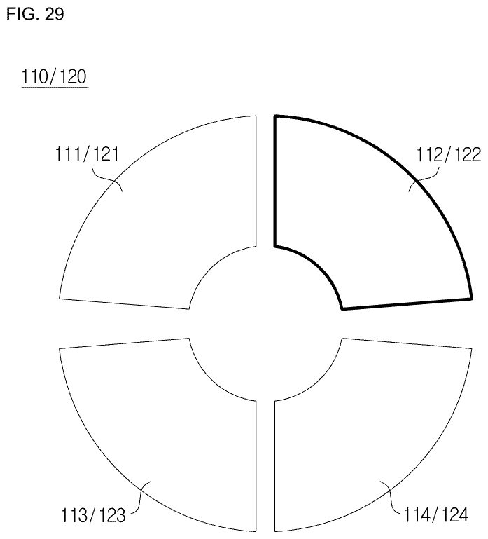

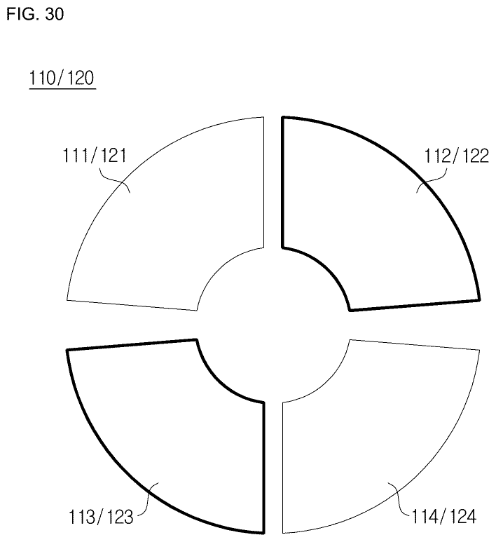

FIG. 29 shows that the second segment 112, 122 is made of a different material than the remaining segments. FIG. 30 shows that the second segment 112, 122 and the third segment 113, 123 are made of a different material than the remaining segments (opposite segments are made of the same material).

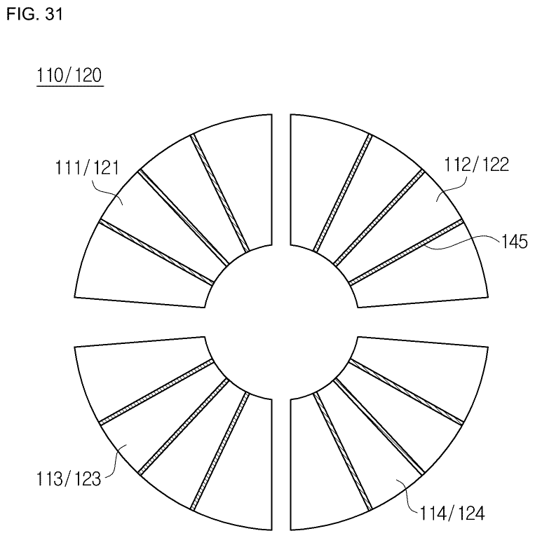

FIG. 31 shows that magnetic inserts 145 are provided within the segments 111, 112, 113, 114 or 121, 122, 123, 124, for adhesion of brake dust. This way, metallic dust can be collected and the environment is protected, even if the shell 100 does not provide a full hull.

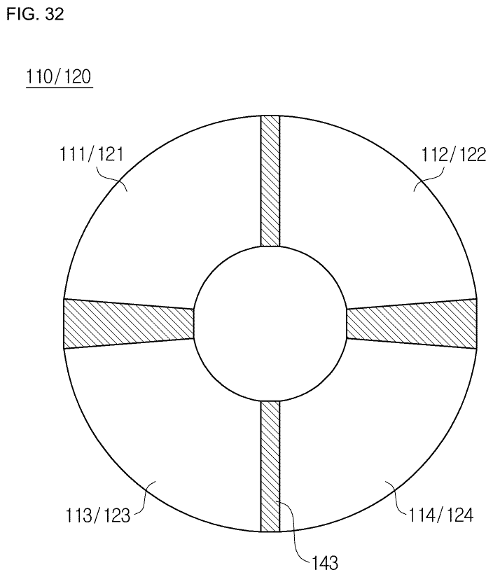

FIG. 32 shows an option for connecting the segments 111, 112, 113, 114 or 121, 122, 123, 124 to each other by plug connections 143.

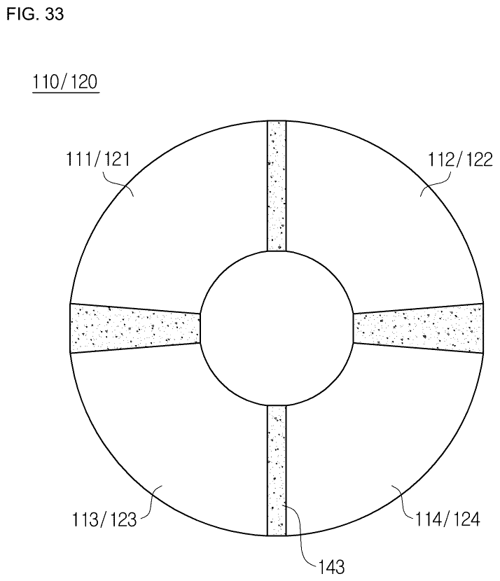

FIG. 33 shows an option for connection the segments 111, 112, 113, 114 or 121, 122, 123, 124 to each other by an adhesive 144.

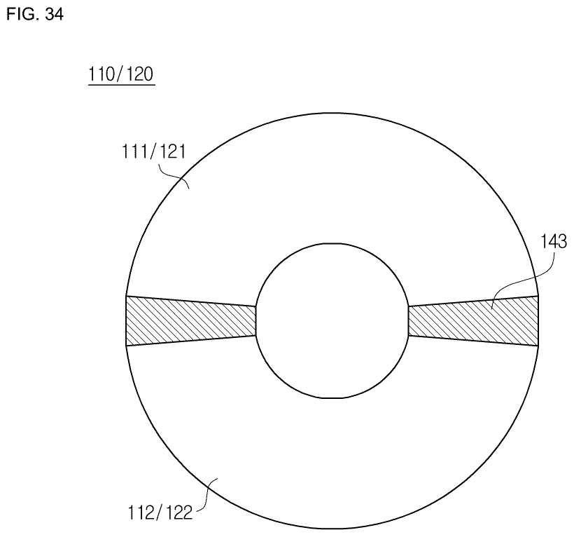

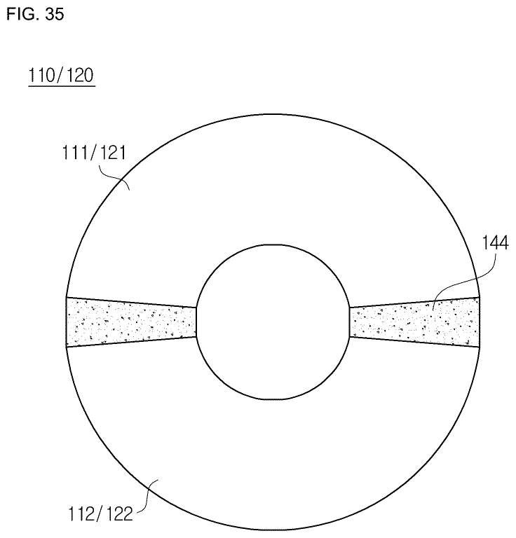

FIGS. 34 and 35 relate to embodiments, where the outer portion 110 or inner portion 120 is composed, in each case, of two segments 111, 112 or 121, 122. FIG. 34 shows connection by way of a plug connection 143. FIG. 35 shows connection by way of an adhesive 144.

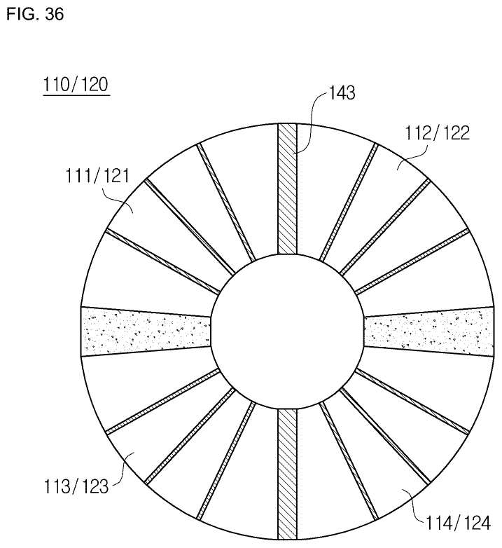

FIG. 36 shows an embodiment where the segments 111, 112, 113, 114 or 121, 122, 123, 124 comprise magnetic inserts 145, wherein both plug connections 143 and adhesive connections 144 are provided for connecting neighbouring segments.

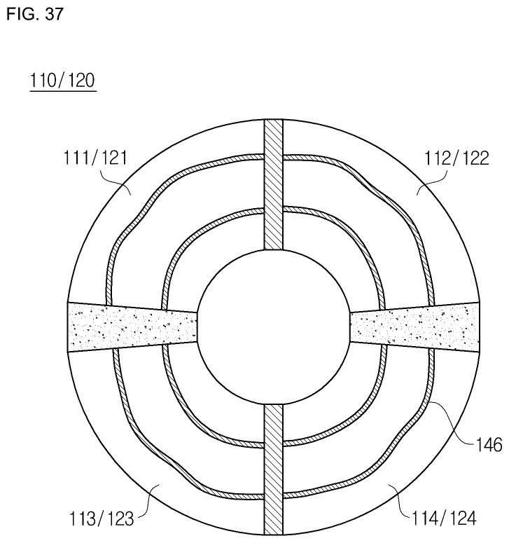

FIG. 37 shows an embodiment, where the shell 100, on the outer portion 110 and/or the inner portion 120, comprises a coating layer 146 for adhesion of brake dust. The coating layer 146 is made of an adhesive material and helps to collect dust emitted from the brake system.

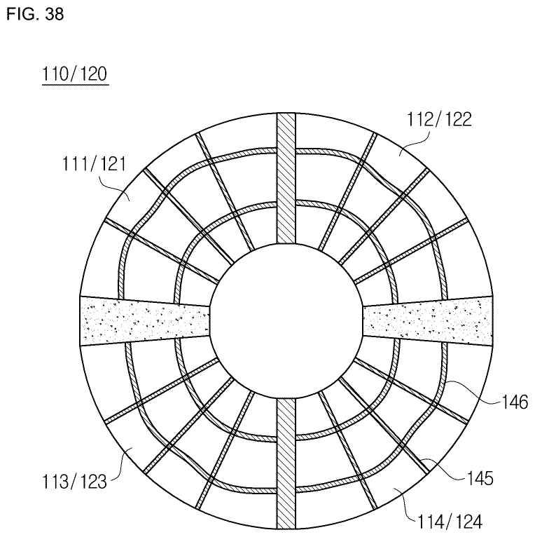

FIG. 38 shows an embodiment, where the where the shell 100, on the outer portion 110 and/or the inner portion 120, comprises both the coating layer 146 for adhesion of brake dust, and the magnetic inserts 145.

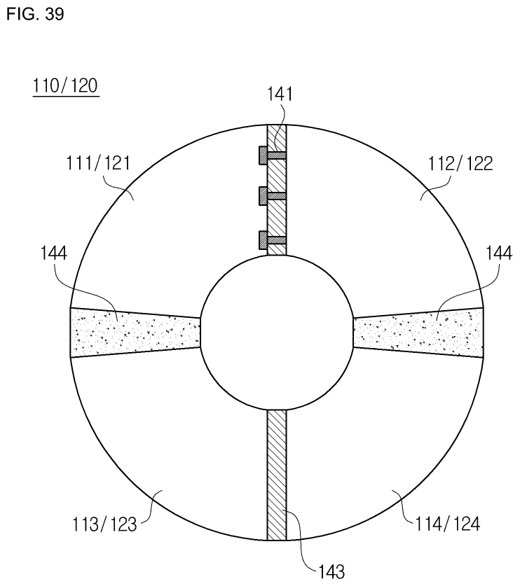

FIG. 39 relates to an embodiment, wherein the first segment 111, 121 is connected to the second segment 112, 122 by way of bolts 141, the second segment 112, 122 is connected to the fourth segment 114, 124 by way of an adhesive 144, the fourth segment 114, 124 is connected to the third segment 113, 123 by way of a plug connection 143, and the third segment 113, 123 is connected to the first segment 111, 121 by way of an adhesive 144.

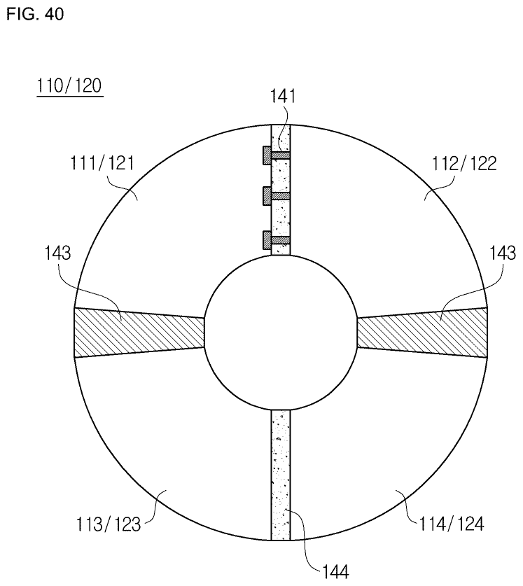

FIG. 40 relates to an embodiment, wherein the first segment 111, 121 is connected to the second segment 112, 122 by way of bolts 141, the second segment 112, 122 is connected to the fourth segment 114, 124 by way of a plug connection 143, the fourth segment 114, 124 is connected to the third segment 113, 123 by way of an adhesive 144, and the third segment 113, 123 is connected to the first segment 111, 121 by way of a plug connection.

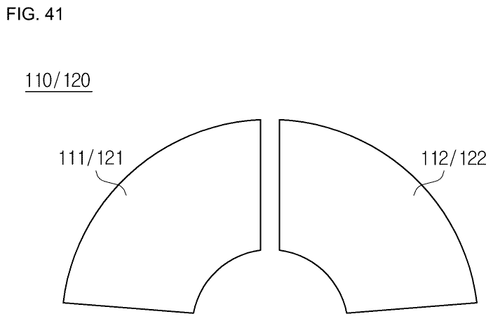

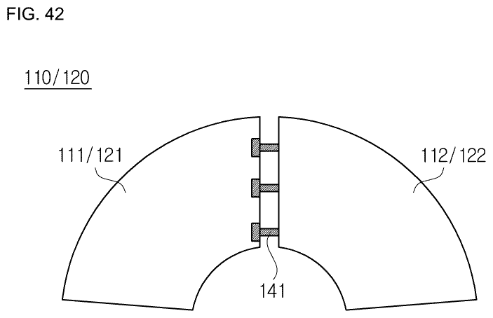

FIGS. 41 and 42 show embodiments, wherein the outer portion 110 is configured to cover only half of the outer side of the brake drum 11 and/or wherein the inner portion 120 is configured to cover only half of the inner side of the brake drum 11. This corresponds for instance to the examples shown in FIG. 12, 14, 19, or 23. The respective portion comprises in each case two segments 111/121 and 112/122, each segment once again covering about a quarter of the respective side. FIG. 42 shows that the segments 111 and 112 or 121 and 122 may be connected by way of bolts 141.

What is claimed is:

1. A drum brake system for a vehicle, comprising a brake drum and a shell, the shell at least partially encasing the brake drum at an axially outer side and/or an axially inner side and/or a circumferentially outer side.

2. The drum brake system according to claim 1, wherein the shell is configured to rotate along with the brake drum, the shell preferably being attached to a wheel and/or an axle.

3. The drum brake system according to claim 1, wherein the shell comprises a first outer segment being configured to cover at least a portion of the axially outer side of the brake drum, the first outer segment optionally being connected to the wheel hub, preferably removably connected to the wheel hub.

4. The drum brake system according to claim 1, wherein the shell comprises a first inner segment, configured to cover at least a portion of the axially inner side of the brake drum.

5. The drum brake system according to claim 4, wherein the shell comprises a first outer segment being configured to cover at least a portion of the axially outer side of the brake drum, the first inner segment is connected to the first outer segment, preferably removably connected to the first outer segment, and/or wherein the first inner segment is connected to the rim and/or to an axle.

6. The drum brake system according to claim 1, wherein the shell is configured to be non-rotating, such that the brake drum rotates within the shell, the shell preferably being configured to be attached to a wheel arch.

7. The drum brake system according to claim 6, wherein the shell comprises at least a first inner segment configured to cover at least a portion of the axially inner side of the brake drum, the first inner segment being connected, preferably removably connected, to the wheel arch.

8. The drum brake system according to claim 1, wherein the shell comprises a coating layer for adhesion of brake dust.

9. The drum brake system according to claim 1, wherein the shell comprises magnetic inserts for collecting metallic brake dust.

10. The drum brake system according to claim 1, wherein the shell comprises at least two segments that are connected to each other, preferably by an adhesive and/or by at least one bolt and/or by at least one screw.

11. The drum brake system according to claim 10, wherein at least two of the at least two segments are made of a different material from each other.

12. The drum brake system according to claim 1, wherein the shell, at least in a section, comprises at least to layers, preferably of different materials from each other.

13. The drum brake system according to claim 1, wherein the shell is transparent, at least in a section.

14. The drum brake system according to claim 1, wherein the shell comprises at least one cleaning opening, for rinsing an interior space of the shell and/or for applying suction to the inner space of the shell.

15. The drum brake system according to claim 1, wherein a distance between an inner surface of the shell and the brake drum is at least 10 mm.

16. The drum brake system according to claim 1, wherein the shell only partially encases the axially outer side and/or the axially inner side of the brake drum, leaving at least 25% of an area of the axially inner side and/or an area of the axially outer side of the brake drum exposed.

17. The drum brake system according to claim 1, configured as a brake system for an electric vehicle and/or as a brake system for a rear axle.
